(19) United States
(12) Patent Application Publication
(10) Pub. No.: US 2026/0163970 A1
(43) Pub. Date: Jun. 11, 2026

(54) AI-BASED GIF FILE RECOMMENDATION SYSTEM

(71) Applicant: East Coast IP, LLC, Raleigh, NC (US)

(72) Inventor: Russell Speight VanBlon, Raleigh, NC (US)

(21) Appl. No.: 18/975,276

(22) Filed: Dec. 10, 2024

(51) Int. Cl. H04M 1/72439; G06F 40/205; H04M 1/72436

(52) U.S. Cl. CPC H04M 1/72439; G06F 40/205; H04M 1/72436

(57) ABSTRACT

Graphic interchange format (GIF) files may be recommended during text messaging based on the identified proclivities of the message sender and/or message recipient. For example, the sender and recipient may both enjoy a certain type of humor, and so the system may recommend GIF files with content that matches that type of humor. The sense of humor of the sender and/or recipient may be determined during a configuration process where the user is presented with different GIF files and indicates which ones the user finds humorous. The user’s selections may then be used to train a GIF recommendation engine to recommend GIF files according to the user’s sense of humor. However, also note that other proclivities may be encompassed by present principles, including proclivities towards types of digital content that users believe convey joyous, melancholy, and frustrated sentiments.

### FIELD

The disclosure below relates to technically inventive, non-routine solutions that are necessarily rooted in computer technology and that produce concrete technical improvements. In particular, the disclosure below relates to artificial intelligence-based graphic interchange format (GIF) file recommendation systems.

### BACKGROUND

As recognized herein, client devices currently lack the technical capability to provide rich content suggestions to users during text messaging. No adequate solutions currently exist to the foregoing computer-related, technological problem.

### SUMMARY

Accordingly, in one aspect an apparatus includes a processor system and storage accessible to the processor system. The storage includes instructions executable by the processor system to execute a model to parse first user input of text to a text messaging application (app). The instructions are further executable to receive, from the model based on the parsing of the first user input, a first output indicating a first graphic interchange format (GIF) file to recommend via the text messaging app. Based on the first output, the instructions are executable to present a first selector on a first graphical user interface (GUI) associated with the text messaging app. The first selector is selectable to select the first GIF file to transmit using the text messaging app.

In certain example implementations, the instructions may be executable to execute the model to, based on a sender and a recipient having a first correlation, provide the first output indicating the first GIF file to recommend via the text messaging app. Here, the instructions may be further executable to execute the model to, based on the sender and the recipient having a second correlation different from the first correlation, provide a second output indicating a second GIF file to recommend via the text messaging app. The second GIF file may be different from the first GIF file. In certain specific instances, the first and second correlations may be associated with different senses of humor and might even be made based on the personal relationship between the sender and the recipient.

What’s more, in certain examples the instructions may be executable to, as part of a GIF file recommendation configuration process, present a second GUI that indicates a second GIF file. The second GUI may include a prompt for the sender to provide second user input indicating whether the sender finds the second GIF file humorous. The instructions may also be executable to receive the second user input. Then the instructions may be executable to, also as part of the GIF file recommendation configuration process and responsive to receipt of the second user input, present a third GUI that indicates a third GIF file. The third GUI may include a prompt for the sender to provide third user input indicating whether the sender finds the third GIF file humorous. The third GIF file may be different from the second GIF file. From there the instructions may be executable to receive the third user input, and then to train the model using the second and third user inputs.

In various example implementations, the first selector may be presented via the text messaging app without a user selecting a second selector through the text messaging app to present a list of GIF files.

Also in some example implementations, the model may include an artificial neural network (ANN), such as a feed-forward neural network and/or a convolutional neural network.

Also if desired, the apparatus may include a display on which the first GUI may be presented.

In another aspect, a method includes parsing first user input of text to a text messaging application (app). The first user input is provided by a message sender. The method also includes, based on the parsing of the first user input, recommending a first graphic interchange format (GIF) file via the text messaging app. The first GIF file is recommended based on a sense of humor parameter. Based on selection of the first GIF file via the text messaging app, then method then includes transmitting the first GIF file to the message recipient using the text messaging app.

In some non-limiting instances, the method may include executing a model to parse the first user input and to infer the first GIF file to recommend. The first GIF file may be recommended based on a correlation between the message recipient’s sense of humor and the message sender’s sense of humor. And in some cases, the method may even include, as part of a sense of humor evaluation, presenting a first graphical user interface (GUI) on a display. The first GUI may include a second GIF file and may prompt a user to provide second user input indicating whether the user finds the second GIF file humorous. The model may then be trained using the second input. The user may be the message sender or the message recipient.

In still another aspect, an apparatus includes at least one computer readable storage medium (CRSM) that is not a transitory signal. The at least one CRSM includes instructions executable by a processor system to parse first user input of text to an application (app), where the first user input is provided by a message sender. Based on the parsing of the first user input, the instructions are executable to recommend a first file to the message sender. The first file is recommended based on a proclivity of a user. Based on selection of the first file, the instructions are then executable to transmit the first file to a message recipient.

In some non-limiting instances, the app may be an email app.

Also in some non-limiting instances, the proclivity may relate to a particular type of humor, and the first file may be recommended based on the message sender and message recipient being linked to the same particular type of humor. The first file may even be recommended based on receipt of an output from an artificial neural network (ANN) configured for pattern recognition. In one particular instance, the ANN may be trained, based on prior selections of other files in other messaging instances, for identifying types of humor.

The details of the present application, both as to its structure and operation, can be best understood in reference to the accompanying drawings, in which like reference numerals refer to like parts, and in which:

### BRIEF DESCRIPTION OF THE DRAWINGS

FIG. 1 is a block diagram of an example computing system consistent with present principles;

FIG. 2 shows a graphical user interface (GUI) that may be presented on a display at a message sender’s device during a live text messaging instance, with the GUI presenting different GIF files for selection that the sender’s device has identified for recommendation consistent with present principles;

FIG. 3 shows example logic in flowchart format that may be executed by an apparatus to recommend a GIF file during text messaging consistent with present principles;

FIGS. 4 and 5 show example GUIs that may be presented on a display during a sense of humor evaluation process to then train an AI model consistent with present principles;

FIG. 6 shows example logic in flowchart format that may be executed to train the model using the sense of humor evaluation process consistent with present principles;

FIG. 7 shows example artificial intelligence (AI) architecture for an ML-based model that may be implemented consistent with present principles; and

FIG. 8 shows an example GUI that may be presented on a display for an end-user to configure one or more setting of a device or text messaging app to undertake present principles.

### DETAILED DESCRIPTION

This disclosure relates generally to aspects of consumer electronics (CE) devices and other types of client devices and servers. Thus, devices herein may include server and client components which may be connected over a network such that data may be exchanged between the client and server components. The client components may include one or more computing devices including mobile smart phones and other mobile devices, wearable devices, game consoles, extended reality (XR) headsets such as virtual reality (VR) headsets and augmented reality (AR) headsets, display devices such as televisions (e.g., smart TVs, Internet-enabled TVs), personal computers such as laptops, desktop, and tablet computers, and still other types of devices. These client devices may operate with a variety of operating environments. For example, a client device consistent with present principles may employ, as examples, Linux and Unix operating systems, operating systems from Microsoft, or operating systems from Apple or Google. These operating environments may be used to execute one or more browsing programs, such as a browser made by Microsoft, Apple, Google, or Mozilla. The operating environments may also be used to execute other Internet-networked dedicated mobile applications that can access websites hosted by the Internet servers over a network such as the Internet, a local intranet, or a virtual private network.

Servers and/or gateways may be used that may include one or more processors executing instructions that configure the servers to receive and transmit data over a network such as the Internet. Or a client and server can be connected over a local intranet or a virtual private network. A server or controller may be instantiated by a personal computer, mobile device, rack or blade server, etc.

As indicated above, information may be exchanged over a network between client devices and servers. To this end and for security, servers and/or clients can include firewalls, load balancers, temporary storages, and proxies, and other network infrastructure for reliability and security.

As used herein, instructions may refer to computer-implemented steps for processing information in the system. Instructions can be implemented in software, firmware or hardware, or combinations thereof and include any type of programmed steps undertaken by components of the system.

A processor may be any single- or multi-chip processor that can execute logic by means of various lines such as address lines, data lines, and control lines and registers and shift registers. Moreover, any logical blocks, modules, and circuits described below can be implemented or performed with a processor/processor system such as a central processing unit (CPU), a digital signal processor (DSP), a field programmable gate array (FPGA) or other programmable logic device, an application specific integrated circuit (ASIC), discrete gate or transistor logic, discrete hardware components, or any combination thereof designed to perform the functions described herein. A processor can be implemented by a controller or state machine or a combination of computing devices.

Software modules described by way of the flow charts and user interfaces herein can include various sub-routines, procedures, etc. Without limiting the disclosure, logic stated to be executed by a particular module can be redistributed to other software modules and/or combined together in a single module and/or made available in a shareable library.

The functions and methods described below, when implemented in software, can be written in an appropriate language such as but not limited to hypertext markup language (HTML)-5, Java®/Javascript, C# or C++, and can be stored on or transmitted from a computer-readable storage medium such as a hard disk drive (HDD) or solid state drive (SSD), random access memory (RAM), read-only memory (ROM), electrically erasable programmable read-only memory (EEPROM), compact disk read-only memory (CD-ROM) or other optical disk storage such as digital versatile disc (DVD), magnetic disk storage or other magnetic storage devices including removable thumb drives, etc. A connection may establish a computer-readable medium. Such connections can include, as examples, hard-wired cables including fiber optics and coaxial wires and digital subscriber line (DSL) and twisted pair wires.

In an example, a processor system can access information over its input lines from data storage, such as a computer readable storage medium as referenced above, and/or the processor system can access information wirelessly from an Internet server by activating a wireless transceiver to send and receive data. Data typically is converted from analog signals to digital by circuitry between the antenna and the registers of the processor system when being received and from digital to analog when being transmitted. The processor system then processes the data through its shift registers to output calculated data on output lines, for presentation of the calculated data on the device, etc.

Components included in one embodiment can be used in other embodiments in any appropriate combination. For example, any of the various components described herein and/or depicted in the Figures may be combined, interchanged, or excluded from other embodiments.

“A system having at least one of A, B, and C” (likewise “a system having at least one of A, B, or C” and “a system having at least one of A, B, C”) includes systems that have A alone, B alone, C alone, A and B together, A and C together, B and C together, and/or A, B, and C together.

The term “a” or “an” in reference to an entity refers to one or more of that entity. As such, the terms “a” or “an”, “one or more”, and “at least one” can be used interchangeably herein.

The term “circuit” or “circuitry” may be used in the summary, description, and/or claims. The term “circuitry” includes all levels of available integration, e.g., from discrete logic circuits to the highest level of circuit integration such as VLSI, and includes programmable logic components programmed to perform the functions of an embodiment as well as processors (e.g., special-purpose processors) programmed with instructions to perform those functions.

Note that present principles may also employ machine learning models, including deep learning models. Machine learning models use various algorithms trained in ways that include supervised learning, unsupervised learning, semi-supervised learning, reinforcement learning, feature learning, self-learning, and other forms of learning. Examples of such algorithms, which can be implemented by computer circuitry, include one or more neural networks, such as one or more convolutional neural networks (CNNs) and/or one or more recurrent neural networks (RNNs) (such as a type of RNN known as a long short-term memory (LSTM) network). Support vector machines (SVM) and Bayesian networks also may be considered to be examples of machine learning models.

As understood herein, performing machine learning involves accessing and then training a model on training data to enable the model to process further data to make predictions. A neural network may include an input layer, an output layer, and multiple hidden layers in between that are configured and weighted to make inferences about an appropriate output.

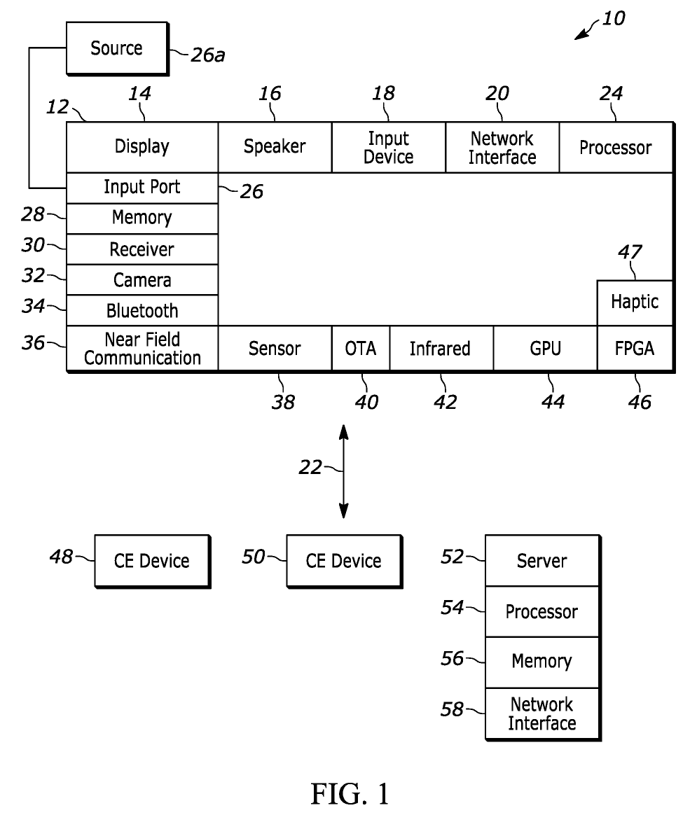

Referring now to FIG. 1, an example system 10 is shown, which may include one or more of the example devices mentioned above and described further below in accordance with present principles. The first of the example devices included in the system 10 is a consumer electronics (CE) device 12. The CE device 12 may be a computerized Internet enabled (“smart”) phone, a tablet computer, a laptop/notebook computer, a desktop computer, a head-mounted device (HMD) and/or headset such as smart glasses or AR or VR headset, another wearable computerized device, etc. Regardless, it is to be understood that the CE device 12 is configured to undertake present principles (e.g., communicate with other CE devices and servers to undertake present principles, execute the logic described herein, and perform other functions and/or operations described herein).

Accordingly, to undertake such principles the CE device 12 can be established by some, or all, of the components shown. For example, the CE device 12 can include one or more touch-enabled displays 14 that may be implemented by a high definition or ultra-high definition “4K” or higher flat screens. The touch-enabled display(s) 14 may include, for example, a capacitive or resistive touch sensing layer with a grid of electrodes for touch sensing consistent with present principles (e.g., to provide input to the GUIs discussed below).

The CE device 12 may also include an analog audio output port 15 to drive one or more external speakers or headphones, and may include one or more internal speakers 16 for outputting audio in accordance with present principles, and at least one additional input device 18 such as an audio receiver/microphone, e.g., for conversing telephonically or for entering audible commands to the CE device 12 to control the CE device 12. The example CE device 12 may also include one or more wired or wireless network interfaces 20 for communication over at least one network 22 such as the Internet, a WAN, a LAN, etc. under control of one or more processors of a processor system 24, such as a CPU or other processor mentioned above. Thus, the interface 20 may be, without limitation, a Wi-Fi transceiver and/or wireless telephony transceiver for communicating over a wireless cellular network (e.g., operated by Verizon, T-Mobile, or AT&T), both of which are examples of a wireless computer network interface.

It is to be understood that the processor system 24 may include one or more processors acting independently or in concert with each other to execute an algorithm (e.g., the algorithms referenced herein), whether those processors are in one device or more than one device. Thus, in some specific examples, the processor system may include a single processor, while in other examples the processor system may include more than one processor. The processor system 24 controls the CE device 12 to undertake present principles, including the other elements of the CE device 12 described herein such as controlling the display 14 to present images thereon and receiving input therefrom. Furthermore, also note the network interface 20 may be a wired or wireless modem or router or other suitable network interface.

In addition to the foregoing, the CE device 12 may also include one or more input and/or output ports 26 such as a high-definition multimedia interface (HDMI) port or a universal serial bus (USB) port to physically connect to another CE device, and/or a headphone port to connect headphones to the CE device 12 for presentation of audio from the CE device 12 to a user through the headphones. For example, the input port 26 may be connected wired or wirelessly to a cable or satellite source 26a of audio video content. Thus, the source 26a may be a separate or integrated set top box, or a satellite receiver. Or the source 26a may be a game console or disk player containing content.

The CE device 12 may further include one or more non-transitory computer memories/computer-readable storage media 28 such as disk-based or solid-state storage that are not transitory signals, in some cases embodied in the chassis/housing of the CE device 12 (e.g., as standalone devices) or as removable memory media or the below-described server(s). Also, in some embodiments, the CE device 12 can include a position or location receiver such as but not limited to a cell phone transceiver, global positioning system (GPS) transceiver, and/or altimeter 30. This transceiver may therefore be configured to receive geographic position information from a satellite or cellphone base station (and/or determine an altitude at which the CE device 12 is disposed) and then provide the information to the processor system 24. However, it is to be understood that another suitable position receiver other than a GPS receiver, cell phone transceiver, and/or altimeter may be used consistent with present principles to determine the location of the CE device 12. In some examples, the GPS transceiver 30 may be located on a streetlight or other infrastructure for which location is to be reported for purposes described in greater detail below.

Continuing the description of the CE device 12, in some embodiments the CE device 12 may include one or more cameras 32 that may be thermal imaging cameras, digital cameras such as webcams, infrared (IR) sensors, and/or other types of cameras or other optical sensors integrated into the CE device 12 and controllable by the processor system 24 to gather pictures/images and/or video consistent with present principles. Also included on the CE device 12 may be a Bluetooth^{®} transceiver 34 and/or other Near Field Communication (NFC) element 36 for communication with other devices using respective Bluetooth and/or NFC wireless technologies/communication standards. An example NFC element can be a radio frequency identification (RFID) element.

Further still, the CE device 12 may include one or more auxiliary sensors 38 that provide input to the processor system 24. For example, one or more of the auxiliary sensors 38 may include one or more pressure sensors forming a layer of the touch-enabled display 14 itself and may be, without limitation, piezoelectric pressure sensors, capacitive pressure sensors, piezoresistive strain gauges, optical pressure sensors, electromagnetic pressure sensors, etc.

Other sensor examples include a motion sensor such as an accelerometer, gyroscope, magnetometer, a speed and/or cadence sensor, an event-based sensor, a gesture sensor (e.g., for sensing gesture command), etc. In one specific example, the sensor 38 thus may be implemented as an inertial measurement unit (IMU) with motion sensors including individual accelerometers, gyroscopes, and magnetometers, and/or other components of that include a combination of accelerometers, gyroscopes, and magnetometers, to determine the location and orientation of the CE device 12 in three dimensions. A gyroscope consistent with present principles may sense and/or measure the orientation of the CE device 12 and provide related input to the processor system 24, an accelerometer consistent with present principles may sense acceleration and/or movement of the CE device 12 and provide related input to the processor system 24, and a magnetometer consistent with present principles may sense and/or measure directional movement of the CE device 12 and provide related input to the processor 122.

The CE device 12 may also include an over-the-air TV broadcast port 40 for receiving OTA TV broadcasts and providing the input to the processor system 24. In addition to the foregoing, it is noted that the CE device 12 may also include an IR transceiver 42 such as an IR data association (IRDA) device. A battery (not shown) may be provided for powering the CE device 12, as may a kinetic energy harvester that may turn kinetic energy into power to charge the battery and/or power the CE device 12. A graphics processing unit (GPU) 44 and field programmable gated array 46 also may be included.

One or more haptics/vibration generators 47 may also be provided for generating tactile signals/vibrations that can be sensed by a person holding or in contact with the device. The haptics generators 47 may thus vibrate all or part of the CE device 12 using an electric motor connected to an off-center and/or off-balanced weight via the motor’s rotatable shaft so that the shaft may rotate under control of the motor (which in turn may be controlled by a processor such as the processor system 24) to create vibration of various frequencies and/or amplitudes as well as force simulations in various directions.

In addition to the CE device 12, the system 10 may include one or more other CE devices/types, which may include some or all of the components mentioned above in relation to the CE device 12. In one example, a second CE device 48 may be established by an Internet of things (IoT) device, a smartphone, a laptop computer, etc. A third CE device 50 is also shown in FIG. 1 and may include similar components as the other CE devices. Thus, in one example, the CE device 50 may be configured as a head-mounted display (HMD) that may include a heads-up transparent or non-transparent display for respectively presenting extended reality (XR) content such as AR content, VR, content, and/or mixed reality (MR) content. The XR content itself might include, as an example, one or more of the GUIs described below, presented stereoscopically. The HMD may be configured as a glasses-type display, or as goggle-type and/or VR-type display vended by various computer hardware manufacturers such as Apple, Oculus, Meta, etc. Or the CE device 50 may be established by a smart streetlight consistent with present principles and, as such, the smart streetlight may include a network communication interface (e.g., Wi-Fi transceiver and/or cellular data transceiver) for communicating with other devices to implement present principles.

In the example shown, only three CE devices are shown, it being understood that fewer or more devices may be used. A device herein may implement some or all of the components shown for the CE device 12. Any of the components shown in the following figures may incorporate some or all of the components shown in the case of the CE device 12.

Now in reference to the afore-mentioned at least one server 52, it includes at least one server processor 54 and at least one tangible computer readable storage medium 56 such as disk-based or solid-state storage. The server 52 also includes at least one network interface 58 that, under control of the server processor 54, allows for communication with other illustrated devices over the network 22 (e.g., the Internet), and indeed may facilitate communication between the server 52 and any other servers/client devices as described herein. Note that the network interface 58 may be, e.g., a wired or wireless modem or router, Wi-Fi or Ethernet transceiver, or other appropriate interface such as, e.g., a wireless telephony transceiver.

Accordingly, in some embodiments the server 52 may be an Internet server or an entire server “farm” of multiple services. If desired, the server 52 may include/perform “cloud” functions such that the devices of the system 10 may access a “cloud” environment via the server 52 in certain example embodiments. Additionally or alternatively, the server 52 may be implemented by one or more computers in the same room as the other devices shown, or nearby.

The components shown in the following figures may include some or all components shown herein. Any user interfaces (UI) described herein may be consolidated and/or expanded, and UI elements may be mixed and matched between UIs. UIs may be presented at a client device like the CE device 12 under control of the client device itself and/or under control of the server 52 as remotely controlling the CE device 12 to present the UIs thereon. Also note that selectors and options on the UIs discussed below may be selected via cursor input, touch input to a touch-enabled display on which the GUI is presented, using voice input, and/or using other input methods.

Present principles may employ various machine learning models, including deep learning models. Machine learning models consistent with present principles may use various algorithms trained in ways that include supervised learning, unsupervised learning, semi-supervised learning, reinforcement learning, feature learning, self-learning, and other forms of learning. Examples of such algorithms, which can be implemented by computer circuitry, include one or more neural networks, such as a convolutional neural network (CNN), a recurrent neural network (RNN), and a type of RNN known as a long short-term memory (LSTM) network. Generative pre-trained transformers (GPTT) also may be used. Support vector machines (SVM) and Bayesian networks also may be considered to be examples of machine learning models. In addition to the types of networks set forth above, models herein may be implemented by classifiers.

As understood herein, performing machine learning may therefore involve accessing and then training a model on training data to enable the model to process further data to make inferences. An artificial neural network trained through machine learning may thus include an input layer, an output layer, and multiple hidden layers in between that are configured and weighted to make inferences about an appropriate output.

With the foregoing in mind, it is to be understood that present principles deal with recommending GIF files to message senders based on the proclivities or parameters of what the sender and/or recipient personally find to convey humorous, joyous, melancholy, or frustrated sentiments in the GIF files they like and select. For simplicity, humorous GIF files will be discussed below in many instances, but it is to be understood that the same principles may apply to other types of GIF files (e.g., joyous, sad, frustrated, etc.) that may also be recommended to the user where appropriate based on the user’s own proclivities for that respective sentiment type as well. Further note that present principles may encompass other file types besides GIF files, including other image-based file formats such as but not limited video file formats and static image/text media files like JPEG and PDF files.

Artificial intelligence (AI) models consistent with present principles may thus employ pattern recognition to determine, from a larger set of GIF files already tagged or classified as humorous (or as another sentiment), GIF files to recommend to the user that are linked to particular types of humor that the user themselves finds enjoyable. The AI model may be trained on the user’s own sense of humor, either through the user’s selections of GIF files in past messaging instances and/or through a configuration process where the user is presented with a series of GIFs of a given sentiment and then provides feedback on whether the user feels that the respective GIF adequately conveys the respective sentiment. Thus, after the AI model has been trained on the sender and/or recipient’s own senses of humor, the AI model can recommend other (different) GIF files that the sender and recipient would still both find funny based on the current context of their message chain, whether those GIF files have been seen before by the users or not.

Note that the GIF files themselves may be presented a continuous loop of moving images that are presented over time in video-like format, with the GIF images often showing motion of individual objects within the GIF’s sequential images. In some examples, GIF files may also include audio that is presented concurrently with the images of the GIF file. Furthermore, text may sometimes be embedded in the GIF image(s) themselves.

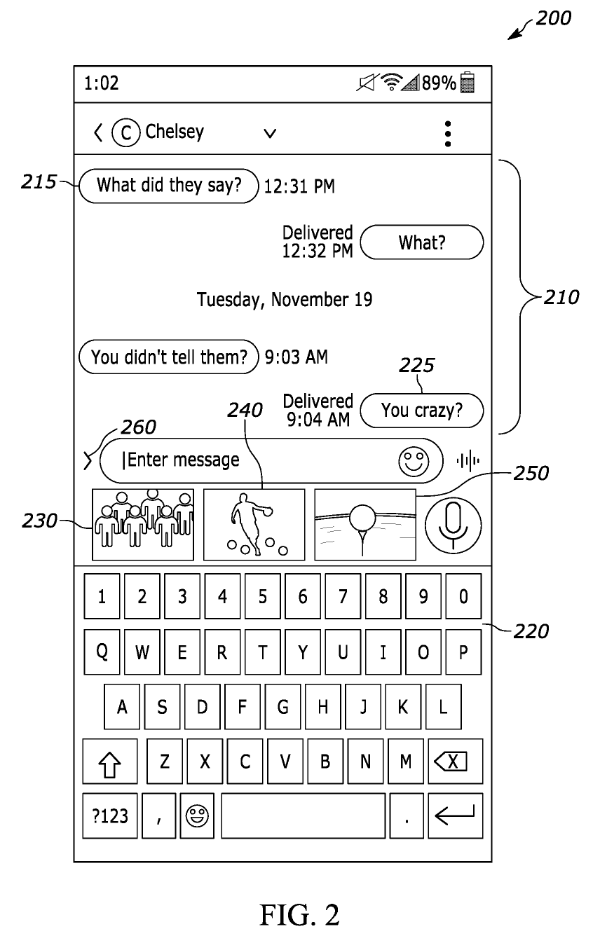

With these aspects in mind, reference is now made to FIG. 2. This figure shows an example graphical user interface (GUI) 200 of a text messaging application (app) executing at a client device. The text messaging app may be a short message service (SMS) and/or multimedia messaging service (MMS) text messaging app, an Internet-based text messaging app such as a social media messenger or email app or encrypted messaging service app, or another type of app through which text-based messages can be exchanged between users.

As shown, a chain of previous messages 210 exchanged between the sender and recipient is shown in area 215. A soft keyboard 220 is also shown for the sender to enter another text message to send to the recipient. However, assume here that the sender has just sent message 225 to the recipient, which indicates “You crazy?” An AI model running in the background may analyze that text using sentiment analysis and other context-identification algorithms to detect a humorous tone of sarcasm in the text message.

Based on the AI model determining as much, the AI model may then recommend one or more sarcastic GIF files 230, 240, and 250 to the user without the user selecting another selector through the text messaging app to present a list of GIF files from which one may be selected. However, note that when such a GIF list is in fact presented (such as responsive to selection of the selector 260), the AI model may still present its own GIF recommendations at the top of that list.

In either case, the GIF files that are recommended here are ones that the AI model has determined match the sender and/or recipient’s own sense of sarcastic humor. In some examples, a match of the humor type of the sender and recipient may be required for GIF recommendation to avoid recommending GIFs that one user or the other might find offensive (or at the very least, not find that humorous). However, in other examples the GIF file may be recommended based on the individual proclivity of the sender or recipient alone.

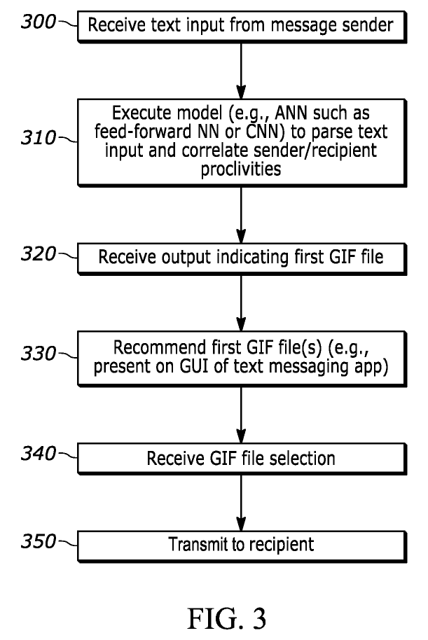

Now in reference to FIG. 3, this figure shows example logic that may be executed by an apparatus such as a client device (e.g., smartphone) and/or a coordinating server alone or in any appropriate combination consistent with present principles. Thus, in some examples the logic may be executed by a client device alone. In other examples, the logic may be executed by the remotely-located server alone. In still other examples, the logic may be executed by a client device and remotely-located server, where the client device performs some steps while the server performs other steps, and/or where the client device and server work together to perform a given step. Further note that while the logic of FIG. 3 is shown in flow chart format, other suitable logic may also be used.

Beginning at block 300, the apparatus may receive first user input of text from a human text message sender. The logic may then proceed to block 310 where the apparatus may execute an AI model to parse the first user input to, at block 320, receive a first output from the model that indicates one or more first GIF files to recommend via the text messaging app.

The logic of FIG. 3 may then proceed to block 330 where the apparatus may recommend the first GIF file(s) to the user, such as by presenting the first GIF files on a GUI of the text messaging app for the user to select one of the GIF files in the same messaging screen (with keyboard) that is already being used for text messaging in a given text message chain. The apparatus may therefore receive the sender’s selection of one of the recommended GIF files to then transmit, at block 350, the GIF file to the human recipient at the recipient’s own client device.

Thus, in one example implementation, the model may be executed to, based on the sender and the recipient having a first correlation, provide a first output indicating a first GIF file to recommend. But the model may also be executed to, based on the sender and the recipient having a second (different) correlation, provide a second output indicating a second (different) GIF file to recommend. For humor in particular, the correlations might be related to different senses of humor like light sense of humor, dark sense of humor, strange sense of humor, outlandish sense of humor, inappropriate sense of humor, sexual sense of humor, etc. Other humor delineations may also be used.

Correlations may additionally or alternatively be based on personal relationship of the sender to the recipient and vice versa. Example personal relationships may include family generally, friends generally, mother-son, mother-daughter, father-son, father-daughter, etc., with the present disclosure recognizing that the sense of humor the same sender employs may vary based on which type of person the sender is texting in terms of personal relationship to the sender.

After block 350 of FIG. 3, the logic may then continue on from there for the apparatus to further train the AI model based on the sender’s most-recent GIF file selection at block 340, further honing the AI model to the sender’s own sense of humor over time as the sender messages people.

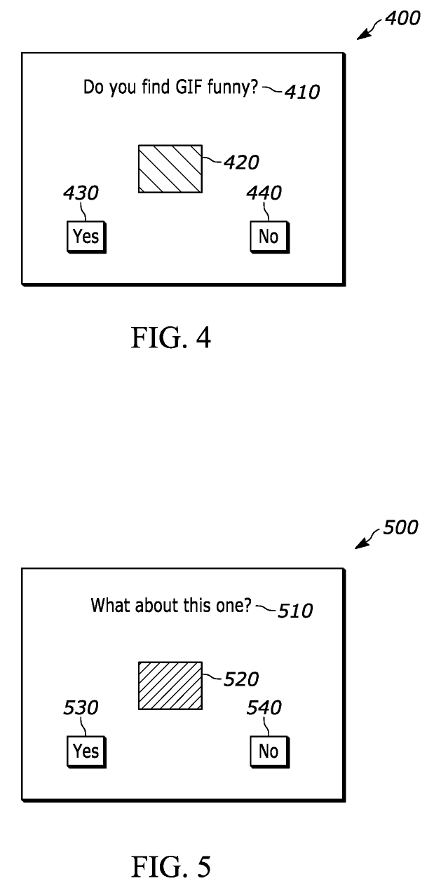

However, note that the AI model may also be trained through a GIF file recommendation configuration process. In some examples, a different AI model may even be trained for each of the sender and recipient so that the senses of humor of the two people can be matched (to thus recommend a corresponding GIF that matches that shared sense of humor). FIGS. 4 and 5 therefore demonstrate the configuration process that either user may engage in, with the process including the presentation of GUIs that the user can use to indicate their sense of humor.

Beginning first with FIG. 4, a GUI 400 may be presented on the display of the user’s client device, such as responsive to the user initiating the configuration process. As shown, the GUI 400 may include a prompt 410 asking the user whether the user finds a GIF 420 to be funny. The user may then provide affirmative input through selection of the “yes” selector 430, or negative input through selection of the “no” selector 440. Responsive to selection of either one, the GUI 500 of FIG. 5 may then be presented.

As shown in FIG. 5, the GUI 500 may include another prompt 510 asking the user whether the user finds another GIF 520 to be funny. The user may then provide affirmative input through selection of the “yes” selector 530, or negative input through selection of the “no” selector 540.

Note that this selection process may be done at least two times as just described, and preferably more than that, for the AI model to be adequately trained to infer GIF files for recommendation according to the user’s sense of humor. Both affirmative and negative inputs may be used for training to determine not just what the user finds funny, but what the user does not find funny. And to reiterate, the AI model may additionally or alternatively be trained on past selections of GIF files that the user found funny in past messaging instances, with those GIFs being accessible for training through past message chains stored locally or in cloud storage.

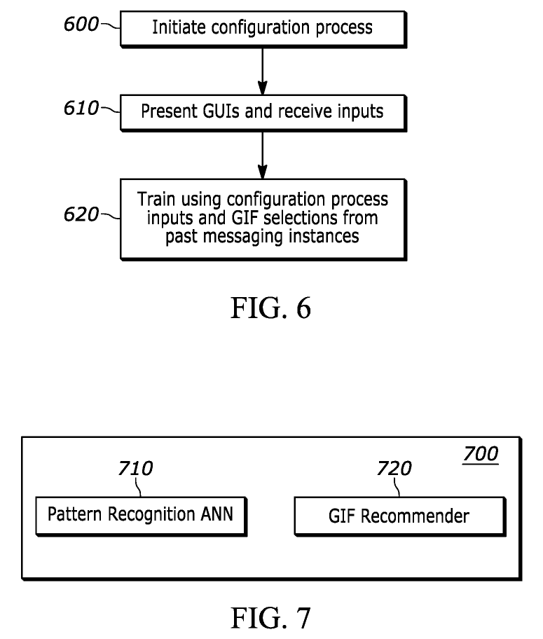

FIG. 6 shows example logic that may be executed by an apparatus to facilitate the configuration process just described. At block 600, the apparatus may initiate the configuration process, such as responsive to user command to configure the AI model or responsive to the user selecting another GIF file during text messaging.

The logic may then proceed to block 610. Here, the apparatus may present GUIs with different GIFs on them and receive inputs from the user as to whether the user finds the respective GIF humorous (or, for other example sentiments, finds the respective GIF joyous, sad, etc.). Available sentiments may include, as examples, feelings of various degrees from a feelings wheel. The logic may then proceed to block 620 where the apparatus may train the AI model using the inputs received through the configuration process, and/or using past GIF selections from past messaging instances as also discussed above.

Note that different types of supervised learning techniques may therefore be used to train the AI model, though other types of machine learning techniques may also be used. In one particular example, the AI model may be trained in supervised fashion using a dataset that includes pairs of respective GIF files and respective ground truth labels for whether the associated GIF file adequately captured the associated sentiment (e.g., humorous) or not according to the user’s own tastes. The positive/negative labels may therefore be assigned to the GIFs through the configuration process above, and/or positive labels may be assigned based on past GIF selections during past messaging instances.

Now in reference to FIG. 7, example artificial intelligence (AI) architecture is shown for an AI model 700 that may be executed consistent with present principles. However, note that the architecture 700 is but an example and that other AI architectures are also encompassed by present principles.

In various non-limiting instances, the AI model 700 may include one or more artificial neural networks (ANNs). As such, the model 700 may include a pattern recognition ANN 710 as established by a feed-forward neural network (FFNN) or convolutional neural network (CNN) configured for pattern recognition (e.g., sentiment analysis). The model 700 may also include a discriminative GIF recommender 720 as established by a support vector machine, decision tree, CNN, FFNN, or other type of discriminative model.

The pattern recognizer 710 may therefore receive, as input, one or more draft text messages and/or sent text messages from a message chain between two or more people. The recognizer 710 may then output an inference of a particular sentiment (e.g., sarcastic humor or other feeling/emotion), which may then be provided as input to the GIF recommender 720. Again note that feelings and emotions available for inference may be those from a feelings wheel in non-limiting examples. The GIF recommender 720 may then use that input along with an indicator of the personal relationship between the two (or more) message participants to infer one or more GIFs to output based on its training of what the one or more of the participants have indicated as adequately conveying the associated sentiment.

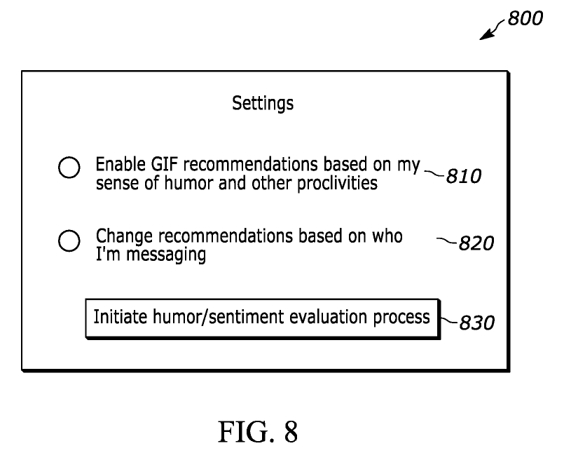

Continuing the detailed description in reference to FIG. 8, it shows an example GUI 800 that may be presented on a display for an end-user to configure one or more settings of an apparatus or text messaging app to operate consistent with present principles. Each option discussed below may be selected by selecting the respective radio button shown adjacent to that option, whether through cursor input, touch input, or another type of input.

As shown, the GUI 800 may include a first option 810 that is selectable to set or enable the text messaging app to recommend GIF files consistent with the disclosure above. Thus, selection of the option 810 may opt the user into GIF recommendations based on the user’s own proclivities and, as such, may set or configure the app to undertake the functions and processes described above in reference to FIGS. 2-7.

The GUI 800 may also include an option 820 that may be selectable to set or configure the app to change the GIF recommendations it makes based on the personal relationship of the user to the person the user is messaging. Thus, selection of the option 820 may cause the app to recommend different GIFs depending not just on the proclivities of the user themselves but the proclivities that user specifically when messaging someone associated with that personal relationship.

If desired, the GUI 800 may also include a selector 830. The selector 830 may be selected to initiate a GIF file recommendation configuration process as described above. Thus, responsive to selection of the selector 830, the GUI 400 of FIG. 4 might be presented.

It may now be appreciated that different types of humorous GIFs may be recommended to a message sender depending on the person with whom the sender is messaging as well as the proclivities of the sender themselves. Training data for each type of relationship to the sender may be used to filter GIFs to send to a given recipient depending on relationship class, with GIF suggestions changing per a specific contact of the sender (e.g., based on relationship, prior GIFs sent to that recipient, etc.).

For example, recognizing that the same sender may have different comfort zones depending on who the messaging recipient is, inappropriately-funny GIFs may be recommended when the user is messaging an old school friend but only light humor GIFs may be recommended when the user is messaging the user’s own mother. But in either case, the GIFs that are recommended may still be ones that the AI model has inferred as ones the user themselves would find funny based on its prior training.

Note that training might also occur for a recipient based on a GIF selection at the sender’s device or based on a permission request from the sender’s device to send a GIF to the recipient. In such an instance, the first training GUI prompt might indicate something like, “Steve wants to send you a GIF, but we’re not sure what your comfort zone is. Here are five images, give me thumbs up or down if any of them go too far.” The training process may then take the user through five separate GUIs with five separate GIFs akin to the process set forth above in reference to FIGS. 4-6 for the system to then discern the recipient’s sense of humor. The model as trained on the recipient may then be deployed to recommend a GIF at the sender’s own device that meets the recipient’s proclivities.

It is to also be understood that present principles may apply to group messages as well as messages between only two messengers. For example, GIF files may be recommended in group texts of three or more people. In one particular instance, a model may be trained just for that group text so that, as the general sense of humor of the group is learned through text-based messages as well as GIFs exchanged between the members of the group, the model may learn what the group thinks is funny and then recommend additional funny GIFs to any of the group’s members at their own respective client devices that are linked to that same proclivity.

In one particular aspect, an apparatus and method consistent with present principles may operate substantially as shown and described above, but may also be claimed as including some but not all aspects in any intermediate claim approach.

Before concluding, it is to be understood that although a software application for undertaking present principles may be vended with a device, present principles apply in instances where such an application is downloaded from a server to a device over a network such as the Internet. Furthermore, present principles apply in instances where such an application is included on a computer readable storage medium that is vended and/or provided by itself, where the computer readable storage medium is not a transitory signal and/or a signal per se.

It may now be appreciated that present principles provide, among other technical improvements, improved computer-based user interfaces that increase the functionality and ease of use of the devices disclosed herein. The disclosed concepts are rooted in computer technology for computers to carry out their functions.

It is to be understood that whilst present principles have been described with reference to some example embodiments, these are not intended to be limiting, and that various alternative arrangements may be used to implement the subject matter claimed herein.

What is claimed is:

1. An apparatus, comprising:
a processor system; and
storage accessible to the processor system and comprising instructions executable by the processor system to:
execute a model to parse first user input of text to a text messaging application (app);
receive, from the model based on the parsing of the first user input, a first output indicating a first graphic interchange format (GIF) file to recommend via the text messaging app; and
based on the first output, present a first selector on a first graphical user interface (GUI) associated with the text messaging app, the first selector being selectable to select the first GIF file to transmit using the text messaging app.

2. The apparatus of claim 1, wherein the instructions are executable to:
execute the model to, based on a sender and a recipient having a first correlation, provide the first output indicating the first GIF file to recommend via the text messaging app; and
execute the model to, based on the sender and the recipient having a second correlation different from the first correlation, provide a second output indicating a second GIF file to recommend via the text messaging app, the second GIF file being different from the first GIF file.

3. The apparatus of claim 2, wherein the first and second correlations are associated with different senses of humor.

4. The apparatus of claim 3, wherein the first and second correlations are made based on personal relationship of the sender to the recipient.

5. The apparatus of claim 3, wherein the instructions are executable to:
as part of a GIF file recommendation configuration process, present a second GUI that indicates a second GIF file, the second GUI comprising a prompt for the sender to provide second user input indicating whether the sender finds the second GIF file humorous;
receive the second user input;
as part of the GIF file recommendation configuration process and responsive to receipt of the second user input, present a third GUI that indicates a third GIF file, the third GUI comprising a prompt for the sender to provide third user input indicating whether the sender finds the third GIF file humorous, the third GIF file being different from the second GIF file;
receive the third user input; and
train the model using the second and third user inputs.

6. The apparatus of claim 1, wherein the first selector is presented via the text messaging app without a user selecting a second selector through the text messaging app to present a list of GIF files.

7. The apparatus of claim 1, wherein the model comprises an artificial neural network (ANN).

8. The apparatus of claim 7, wherein the ANN comprises one or more of: a feed-forward neural network, a convolutional neural network.

9. The apparatus of claim 1, comprising a display on which the first GUI is presented.

10. A method, comprising:
parsing first user input of text to a text messaging application (app), the first user input provided by a message sender;
based on the parsing of the first user input, recommending a first graphic interchange format (GIF) file via the text messaging app, the first GIF file recommended based on a sense of humor parameter; and
based on selection of the first GIF file via the text messaging app, transmitting the first GIF file to the message recipient using the text messaging app.

11. The method of claim 10, comprising:
executing a model to parse the first user input and to infer the first GIF file to recommend.

12. The method of claim 11, wherein the first GIF file is recommended based on a correlation between the message recipient’s sense of humor and the message sender’s sense of humor.

13. The method of claim 11, comprising:
as part of a sense of humor evaluation, presenting a first graphical user interface (GUI) on a display, the first GUI comprising a second GIF file and prompting a user to provide second user input indicating whether the user finds the second GIF file humorous; and
training the model using the second input.

14. The method of claim 13, wherein the user is the message sender.

15. The method of claim 13, wherein the user is the message recipient.

16. An apparatus, comprising:
at least one computer readable storage medium (CRSM) that is not a transitory signal, the at least one CRSM comprising instructions executable by a processor system to:
parse first user input of text to an application (app), the first user input provided by a message sender;
based on the parsing of the first user input, recommend a first file to the message sender, the first file recommended based on a proclivity of a user; and
based on selection of the first file, transmit the first file to a message recipient.

17. The apparatus of claim 16, wherein the app is an email app.

18. The apparatus of claim 16, wherein the proclivity relates to a particular type of humor, and wherein the first file is recommended based on the message sender and message recipient being linked to the same particular type of humor.

19. The apparatus of claim 18, wherein the first GIF file is recommended based on receipt of an output from an artificial neural network (ANN) configured for pattern recognition.

20. The apparatus of claim 19, wherein the ANN is trained, based on prior selections of other files in other messaging instances, for identifying types of humor.
